(19) United States
(12) Patent Application Publication
(10) Pub. No.: US 2024/0302717 A1
(43) Pub. Date: Sep. 12, 2024

(54) LIGHT MODIFICATION SYSTEM

(71) Applicant: MGMD BrainPower LLC, Tucson, AZ (US)

(72) Inventor: Spencer Boerup, Tucson, AZ (US)

(21) Appl. No.: 18/601,571

(22) Filed: Mar. 11, 2024

Related U.S. Application Data
(60) Provisional application No. 63/451,478, filed on Mar. 10, 2023.

(51) Int. Cl. F21K 5/06; G03B 15/04

(52) U.S. Cl. CPC G03B 15/0442; G03B 15/041

(57) ABSTRACT

A base modifier assembly includes a light modifier and an attachment base, which may be a single device or two separate devices. The light modifier may be removably coupled to the attachment base. The attachment base has one or more coupling features that may removably couple to a lighting element. One or more gels may couple to an inside channel. An additional gel may be stacked upon the other gel. Various light modification elements may be stacked on an end of the light modifier and used independently or simultaneously from each additional modifier.

### INTRODUCTION

To aid in the use of cameras, users of cameras employ various flash and lighting equipment. This flash and lighting equipment may be stand-alone or adapted to couple to a lighting apparatus (e.g., a flash, strobe, and/or constant video light) of a camera. In this manner, the flash and lighting equipment may be used in photography, film, and video shoots. Additionally, various types of light-altering devices may be used in conjunction with the lighting equipment. For example, snoots, gels, grids, filters, diffusers, reflectors, and/or light-directing devices may be used with lighting and flash units to alter the appearance of light.

Currently, attaching light-altering devices to flashes and other lighting equipment presents challenges. For example, current technology includes systems with numerous components and/or unwieldy mechanisms that are easily lost or misplaced. Some current technology also fails to allow adequate interchangeability of various types of light-altering devices with the lighting equipment. For example, some light-altering devices are designed to be paired with a single, specific type of lighting equipment.

Further, in some instances, it may be desirable to use multiple light-altering devices at once. For example, a photographer may desire to use a gel to change the light color of a flash and a grid to diffuse the light of that same flash. Currently, for many types of lighting equipment, there is no simple solution to use multiple light-altering elements without the use of cumbersome attachment schemes. Indeed, current technology often limits the number of light-altering elements to one additional device.

It is with respect to these and other considerations that the technologies described below have been developed. Also, although relatively specific problems have been discussed, it should be understood that the embodiments should not be limited to solving the specific problems identified in the introduction.

### Camera Accessory Housing Device

In aspects of the technology, a base modifier assembly includes a light modifier and an attachment base, which may be a single device or two separate devices. The light modifier may be removably coupled to the attachment base. The attachment base has one or more attachment elements that may removably couple to a light housing or flash housing (e.g., a light source used by photographers). In examples, one or more gel inserts may couple to an interior surface of the attachment base. For example, the body of the attachment base (e.g., a base body) may define a channel on the interior surface adapted to receive a lip or edge of the gel insert as described more fully herein. Other coupling techniques are contemplated, such as a magnetic coupling, as further described herein. An additional gel insert may be stacked upon the other gel and, in examples, removably couple to that gel. Various light-altering devices may also be stacked on an end of the light modifier. Each of the gel inserts and light-altering devices may be used in combination with each other or alone.

In a particular example, a light modification assembly includes an attachment base having an attachment base body defining a base opening having a base interior surface, the base body having a base distal end opposite a base proximal end and at least one base exterior surface, wherein the base exterior surface of the base body includes at least one attachment element capable of removably coupling to a to a light housing or flash housing (e.g., a light source used by photographers).

In examples, the light modification assembly includes a light modifier having a modifier body defining a modifier opening, the modifier body having a modifier distal end opposite a modifier proximal end and at least one modifier exterior surface, and the at least one modifier exterior surface has a modifier coupler removably coupled to at least a portion of the base interior surface.

In some examples, the light modification assembly includes at least one attachment element extending radially from an exterior surface of the base proximal end, and the at least one attachment element is operatively configured to couple with the lighting element or light housing.

In examples, a modifier coupler may comprise a protruded ridge disposed about the light modifier exterior surface. Removably coupling may occur through a friction fit, press fit, or snap fit. The light modifier may further comprise a modifier interior surface defined by the modifier body and disposed within the modifier opening, wherein the modifier interior surface is reflective or semi-reflective. The light modifier is collapsible in some examples. The technology also includes a gel insert with a body and a lip disposed on an outside rim of the base of the gel, the lip removably coupled to a channel disposed about the modifier interior surface or the base interior surface, in some examples. The gel may include a bump circumferentially disposed about an outside surface of the gel. A second gel may have an inside surface with a groove that is configured to fit the bump of the bump of the first gel.

In further aspects of the technology, a stackable light-altering system comprises a base having a base body defining a base opening, the base opening having a base interior surface, wherein the base body has a base distal end opposite a base proximal end and at least one base exterior surface, wherein the base exterior surface of the base body includes at least one engagement element adapted to removably couple to a lighting element, and further wherein the base interior surface comprises a groove; and a first light-altering device having a first body defining a first recess, a first curved outer surface, and a first lip removably coupled to the groove of the base interior surface, the recess having a height and a diameter.

The stackable light-altering system may include a second light-altering device having a second body defining a second recess, a second curved outer surface, a second groove disposed about an interior surface of the second recess, the second recess having a second height and a second diameter; and wherein the first light-altering device has a first protrusion circumferentially disposed about the first curved outer surface and is removably inserted into the second groove. The stackable light-altering system may also include a light modifier having a modifier body defining a modifier opening, the modifier body having a modifier distal end opposite a modifier proximal end and at least one modifier exterior surface, the at least one modifier exterior surface having a modifier coupler removably coupled to at least a portion of the base interior surface. The modifier coupler may comprise a protruded ridge disposed about the modifier exterior surface. Removably coupling may occur through a friction fit, press fit, ferromagnetic coupling, or snap fit. The light modifier may be one of a snoot, a cone, or a softbox. The light modifier may be collapsible. Further aspects of the technology include a light modification apparatus comprising a base area as part of a base body defining a base opening having a base interior surface, the base body having a base distal end opposite a base proximal end and at least one base exterior surface, wherein the base exterior surface of the base body includes at least one attachment element proximate the base proximal end capable of removably coupling to a lighting element; and a light modification area proximate the modifier distal end.

In additional examples, the at least one attachment element is one or more protrusions extending radially from the base exterior surface, and further wherein the at least one attachment element is operatively configured to couple with a lighting element. The interior surface of the attachment base may be reflective or semi-reflective. The light modification apparatus may be collapsible. The light modification apparatus may further comprise a gel having a body and a lip disposed on an outside rim of the base of the gel, the lip removably coupled to a channel disposed radially about the interior surface of either the attachment base or the light modifier. The gel may further comprise a bump circumferentially disposed about an outside surface of the gel. A second gel may have an inside surface with a corresponding channel circumferentially disposed on the inside surface of the gel, and the corresponding channel may be removably coupled to the bump of the gel.

These and various other features as well as advantages that characterize the systems and methods described herein will be apparent from a reading of the following detailed description and a review of the associated drawings. Additional features are set forth in the description, which follows and, in part, will be apparent from the description or may be learned by practice of the technology. The benefits and features of the technology will be realized and attained by the structure particularly pointed out in the written description and claim hereof as well as the appended drawings.

It is to be understood that both the foregoing introduction and the following detailed description are exemplary and explanatory and are intended to provide further explanation of the invention as claimed.

### BRIEF DESCRIPTION OF THE DRAWINGS

Non-limiting and non-exhaustive embodiments are described with reference to the following figures:

FIGS. 1A-1D illustrate various views of an example base modifier assembly comprising an attachment base and a light modifier.

FIG. 2 illustrates an exploded view of an example base modifier assembly comprising an attachment base and a light modifier.

FIG. 3 illustrates a perspective view of an example base modifier assembly coupled to a first additional device.

FIG. 4 illustrates an example of an additional device.

FIG. 5 illustrates an example of an additional device.

FIG. 6 illustrates another example perspective view of an example base modifier assembly coupled to a first additional device.

FIG. 7 illustrates a cross-sectional view of an example base modifier assembly with a gel insert.

FIG. 8 illustrates a perspective view of an example base modifier assembly with a gel insert.

FIG. 9 illustrates a top view of an example base modifier assembly with a gel insert.

FIGS. 10A and 10B illustrate a cross-section view of an example base modifier assembly with two gel inserts.

FIGS. 11A and 11B illustrate an alternative example of an attachment base.

FIGS. 12A and 12B illustrate various views of a base modifier assembly in an un-collapsed configuration.

FIGS. 13A and 13B illustrate various views of a base modifier assembly in a collapsed configuration.

FIG. 14A provides a top-perspective view of an example gel insert.

FIG. 14B provides a bottom-perspective view of an example gel insert.

### DETAILED DESCRIPTION

Before the base modifier assembly and other innovative technologies that are the subject of this disclosure are described, it is to be understood that this disclosure is not limited to the particular structures, process step, or materials disclosed herein but is extended to equivalents thereof as would be recognized by those ordinarily skilled in the relevant arts. It should also be understood that the terminology employed herein is used for the purpose of describing particular examples only and is not intended to be limiting. It must be noted that, as used in this specification, the singular forms “a,” “an,” and “the” include plural referents unless the context clearly dictates otherwise.

Aspects of the technology relate to a base modifier assembly comprising an attachment base and a light modifier. In examples, the light modifier is made of a deformable material and adapted to couple to the attachment base. A cylindrical shape may be used for the attachment base. In an example, the light modifier may have a modifier body with tapered walls (e.g., a portion of the modifier body is frustoconical in shape), and one end of the light modifier may be inserted into an opening of the attachment base, an example of which is referred to as a base opening. A friction fit or press fit may be employed to robustly couple the attachment base to the light modifier. For example, an inside wall of the base opening may have one or more curves, tapers, or ledges that receive a corresponding feature of the light modifier. Examples of such fit are described in further detail with reference to the figures below. In some examples, the attachment base and light modifier may be a single device (e.g., the attachment base and the light modifier are irremovably joined together and/or form a unitary body).

One skilled in the art will appreciate that, in examples, multiple light modifiers may be interchangeably used with an attachment base. For example, the attachment base may removably couple to various light modifiers. Using various light modifiers with a single attachment base coupled to a lighting device or light housing provides a significant advantage to photographers and videographers for some applications. The ability to couple different light modifiers to the attachment base offers versatility and flexibility in a lighting setup. In some applications, by attaching or detaching different light modifiers, such as a snoot, cone, or softbox, to an attachment base coupled to lighting equipment, users can easily adjust the light output to achieve their desired effect. For certain applications, this greatly simplifies the lighting process and allows for quick and efficient adjustments on set. Indeed, the attachment base may stay coupled to the lighting equipment while the photographer swaps out various light modifiers onto the attachment base. In some applications, this provides a convenient and reliable solution for lighting modification, making it a valuable addition to any photographer or videographer's equipment.

Further aspects of the technology include one or more additional light-altering devices removably coupled to a peripheral end of the light modifier. For example, one or more of a planar gel, a dome, a grid, a filter, a snoot, a light diffuser, and/or other light-directing devices may be coupled to a peripheral end of the light modifier. In an example, coupling occurs such that a face of the one or more additional light-altering devices are removably coupled substantially flush to a face of the light modifier, examples of which are provided below with reference to a face modifier. In examples, removable coupling to a face of a light modifier includes the use of clasps, bolts, clamps, hook and loop fasteners, magnets, and/or ferromagnetic material.

One skilled in the art will appreciate the advantages of having the ability to removably couple one or more additional light-altering devices to a peripheral end of a light modifier. For example, the ability to couple one or more additional light-altering devices to a face of a light modifier provides a high level of customization and control in the field of lighting. By being able to remove, add, and/or stack various elements such as gels, filters, grids, and diffusers, users have the ability to fine-tune the light output to their desired specifications in certain applications. This level of customization greatly improves the quality and consistency of the final product compared to current solutions for certain applications. The ease of adding or removing light-altering devices allows for quick and efficient adjustments on set, reducing setup time and increasing productivity. The innovative technologies described herein offers, for some applications, a new level of control and customization in lighting.

Additional aspects of the present technology relate to stackable light-modifying devices, such as planar gels, dome gels, grids, etc., capable of removably coupling to an interior surface of a base modifier assembly, such as an interior surface of the base modifier assembly described with reference to the figures below. In particular aspects, a dome gel couples to the interior surface of an attachment base, (e.g., the base interior surface described below) and/or the interior surface of a light modifier. For certain applications, stackable light-altering elements, such as gels, provides numerous benefits to the lighting industry. For example, stackable light-altering elements may be designed to stack on top of one another, allowing for easy customization and adjustment of the color and intensity of light coming from the lighting equipment. For certain applications, the use of the stackable light-modifying devices significantly reduces the time and effort required for lighting setup and enhances the versatility of lighting fixtures in some applications. The stackable design also reduces the space requirement that a light-altering device requires, thus making storage and transportation more convenient. Furthermore, the ability to layer multiple gels allows for a wider range of color options and greater color accuracy, making them desirable for use in a variety of applications, including photography, film, and theatrical productions. The stackable light-altering elements may be made of a durable, long-lasting polymer, ensuring that they provide reliable performance over time. Overall, in some examples, the stackable light-altering element offers a cost-effective and efficient means of controlling light, providing users with greater control over their lighting needs.

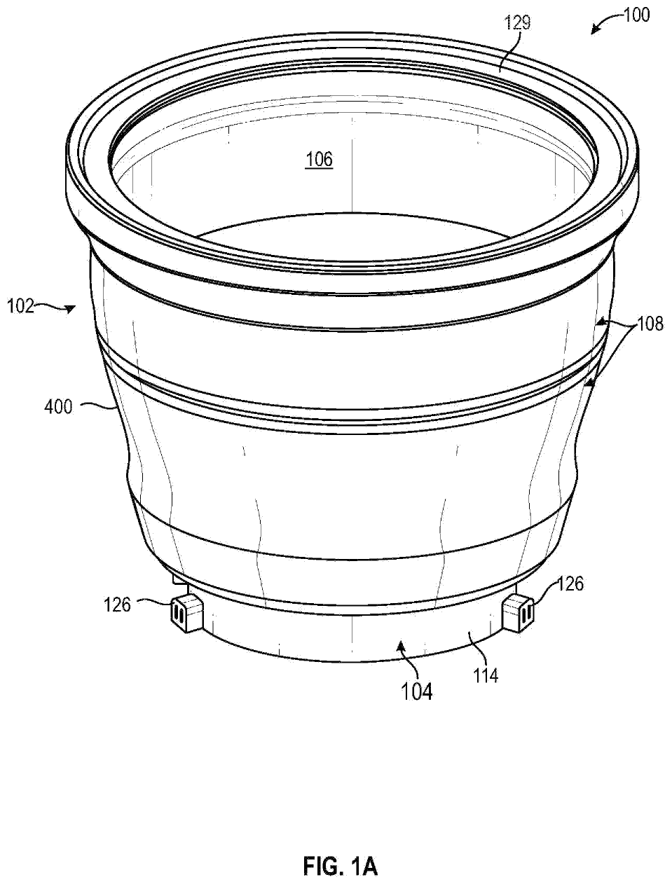

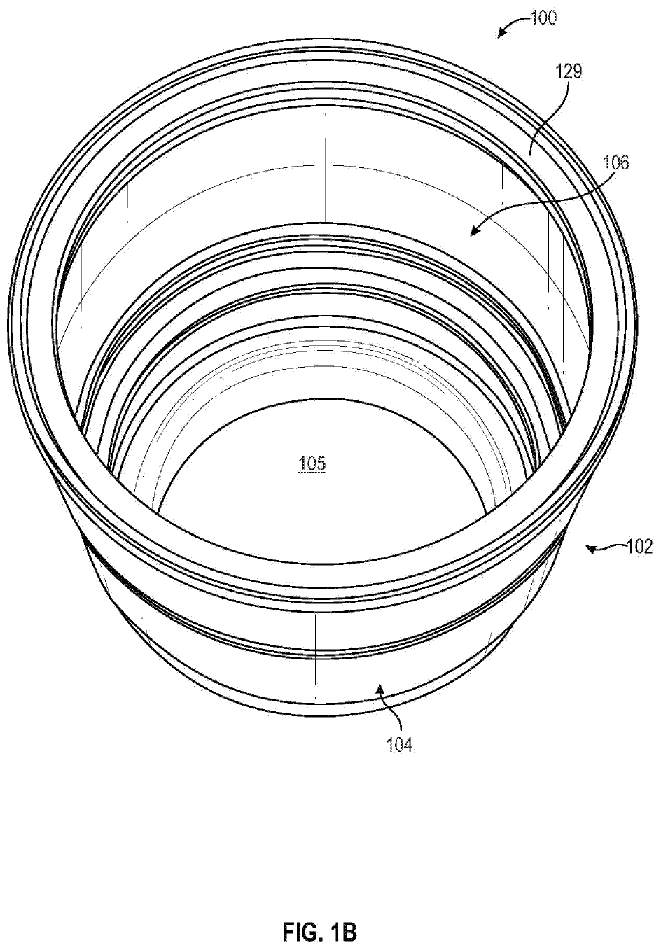

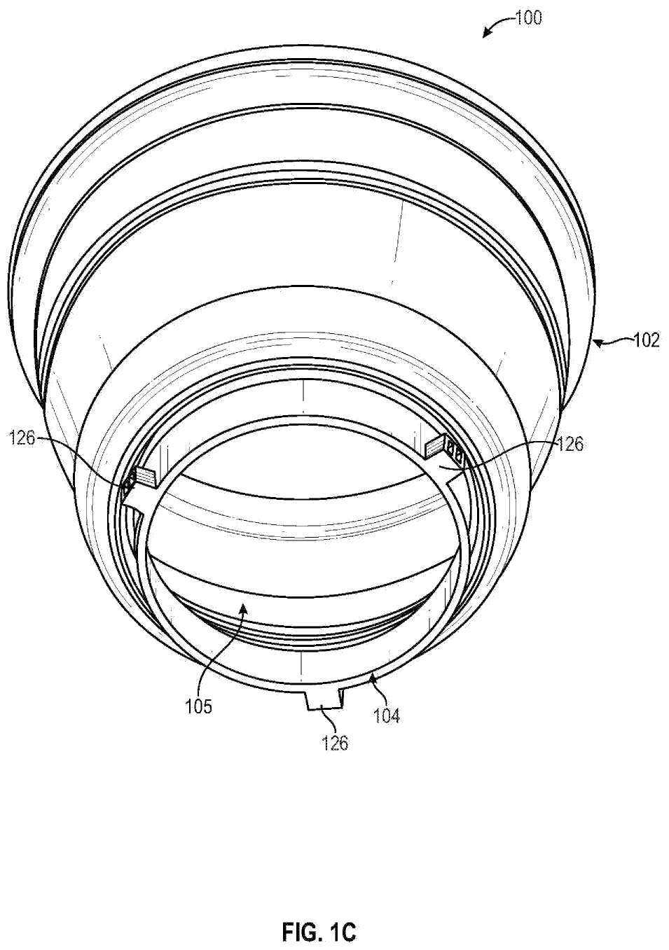

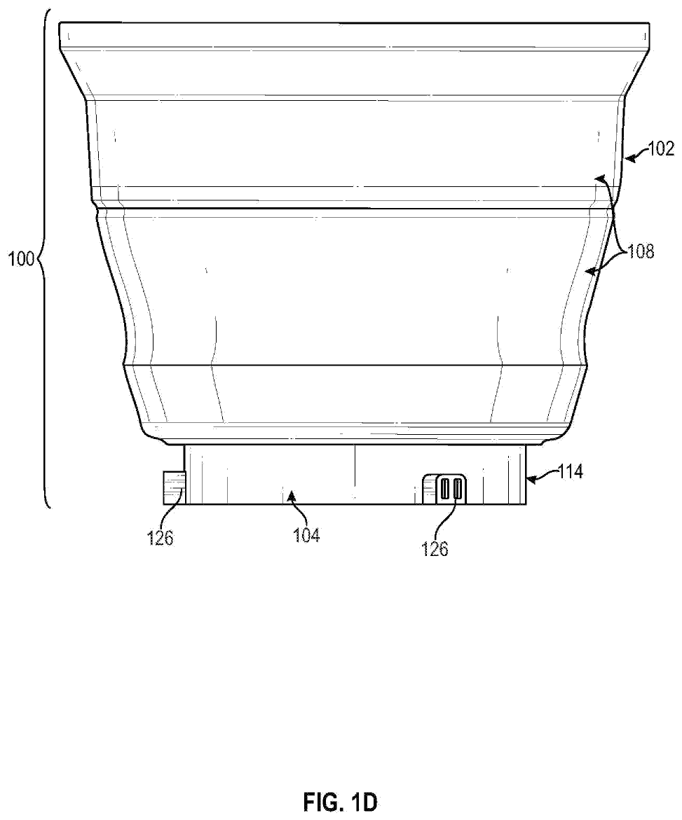

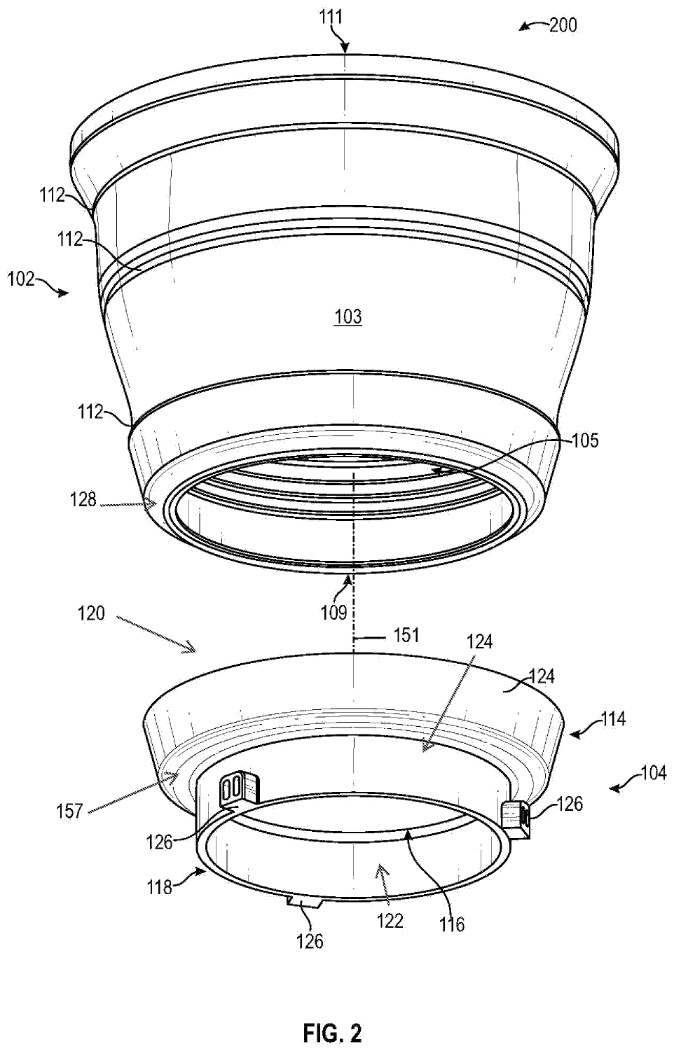

With reference to FIGS. 1A-1D and FIG. 2, FIGS. 1A-1D illustrate various views of an example base modifier assembly 100 comprising an attachment base 104 and a light modifier 102. FIG. 2 illustrates an exploded view of an example base modifier assembly 100 comprising an attachment base 104 and a light modifier 102. It will be appreciated that like-numbered elements are the same or similar to each other.

As illustrated, the light modifier 102 is frustoconical in shape, having a modifier body 103 defining a modifier opening 105. The modifier opening 105 passes from a modifier proximal end 109 (e.g., proximal to the light source, not shown) to a modifier distal end 111 (e.g., distal to the light source, not shown). The modifier opening 105 forms a modifier interior surface 106 of the modifier body 103 of the light modifier 102. In aspects of the technology, the modifier interior surface 106 is (or is coated with) a reflective or semi-reflective material.

Additionally, the modifier body 103 has a modifier exterior surface 108. A modifier face 129 may be a substantially planar ridge located near the modifier distal end of the modifier body 103. A modifier face 129 may be adapted to receive one or more additional light-altering devices, such as a first additional light-altering device 400 and a second additional light-altering device 500 described in further detail below.

The modifier body 103 may be made of a variety of materials. In examples, the modifier body 103 may comprise at least one of a rigid plastic, one or more metals, a flexible plastic, and/or an elastomeric plastic. For certain applications, a flexible, elastomeric material is desired to provide additional versatility and assist with a collapsible design, as further described herein. The modifier body 103 may be made of a single material or multiple materials, including both rigid plastics or metals and elastomeric materials.

Additionally, the modifier body 103 may be collapsible. In examples, collapsing the modifier body 103 occurs by applying a force parallel to an axis 151, which passes through the modifier opening 105. Collapsing may be facilitated by creases 112 in the modifier body 103. Creases 112 may be formed by removing a portion of the modifier body 103 to encourage the body to fold along the crease 112. In some examples, the creases 112 are made of a different, more flexible material than the at least a portion of the rest of the modifier body 103. In some examples, creases 112 may be formed by removing a portion of the modifier body 103 along the creases 112. Further, in some examples, the modifier body 103 is made of a flexible material that can deform to facilitate collapsing, such as plastic, silicone, and or foam. The modifier body 103 may comprise multiple types of material, including hard plastics, flexible plastics, silicone, and the like.

Additionally illustrated is the attachment base 104, which includes a base body 114 defining a base opening 116. The illustrated attachment base 104 has a base proximal end 118 (e.g., proximal to the light source, not shown) and a base distal end 120. The base opening 116 of the attachment base 104 passes through the base proximal end 118 to the base distal end 120, forming a base interior surface 122 and a base exterior surface 124.

The base body 114 may be made of a variety of materials. In examples, the base body 114 is made of at least one of rigid plastic or metal for durability and stability and flexible, elastomeric materials to allow for bending or flexing of the base body 114. For some applications, the base body 114 is at least partially made of a heat-resistant material. In examples, the base body 114 is coupled to a lighting element or light source housing (not shown), as further described herein. Having the base body 114 comprise a heat-resistant material may be advantageous where a lighting source produces heat. For example, where the base body 114 comprises a heat-resistant material, the base body 114 may resist damage caused by heat produced from a lighting source. For certain applications, a flexible, elastomeric material is desired to provide additional versatility and assist with a collapsible design, as further described herein.

On the base exterior surface 124 disposed near that base proximal end 118 are illustrated attachment elements 126. The illustrated attachment elements 126 are protrusions adapted to be received by a light source or a light source housing. For example, the attachment elements 126 may be received by slots or channels of a light source and/or lighting equipment. The base body 114 may be made of a material capable of elastically deforming so that the base proximal end 118 may be elastically compressed, allowing for deformation such that the attachment elements 126 may be inserted into the light source or light source housing. In applications, the attachment elements 126 may be rigid so as to form a robust coupling with the light source.

In examples, the light modifier 102 is removably coupled to the attachment base 104. Coupling may occur through a variety of means, including hook and loop connections, snaps, friction coupling, etc., referred to herein as a modifier coupler. In particular examples, a ferromagnetic attachment may be employed as a modifier coupler. For example, a modifier coupler may be a bottom surface 128 adapted to removably couple to an attachment base, such as bottom surface 128 of the light modifier 102. In an example, the bottom surface 128 has one or more magnets and/or ferromagnetic materials that magnetically couple to the the attachment base 104. For example, attachment may occur along the interior surface 122, such as by engaging with the inside surface (not shown) of a shelf 157. Engagement may occur via magnets or other coupling means. The illustrated bottom surface 128 is circumferentially disposed on or near the modifier proximal end 109. In examples, the bottom surface 128 engages with a channel or race circumferentially disposed about the base interior surface 122 of the attachment base 104. In an example, the bottom surface 128 may include one or more magnets or ferromagnetic material disposed circumferentially about the bottom surface 128. In other examples, the bottom surface 128 comprises a ferrometallic ring embedded in the modifier body 103. The bottom surface 128 may magnetically correspond to a channel or race on the base interior surface 122. For example, a metallic ring or magnetics may be disposed along the base interior surface 122 (e.g., circumferentially disposed in a channel or race about the base interior surface 122, such as embedded within a material that comprises the shelf 157) such that moving the bottom surface 128 proximate to the channel or race causes magnetic coupling.

In additional/alternative examples, the bottom surface 128 may be sized and shaped to be received by the channel such that a force applied from the modifier distal end 111 toward the modifier proximal end 109 snuggly and removably fits the bottom surface 128 into a corresponding feature, such as the base interior surface 122 of the attachment base 104. Such features may be a ridge, a channel, a race, a grove, or other structural element that robustly couples the base modifier to the light modifier via a friction fit. For example, a user may insert the modifier proximal end 109 of the modifier body 103 of the light modifier 102 into the base distal end 120 of the base opening 116 until the bottom surface slips, snaps, or otherwise engages with the feature, such as via friction or press fit. In aspects, one or more of the attachment base 104 and/or the light modifier 102 is made of a flexible material such that the attachment base 104 and/or the light modifier 102 may elastically deform to assist with coupling.

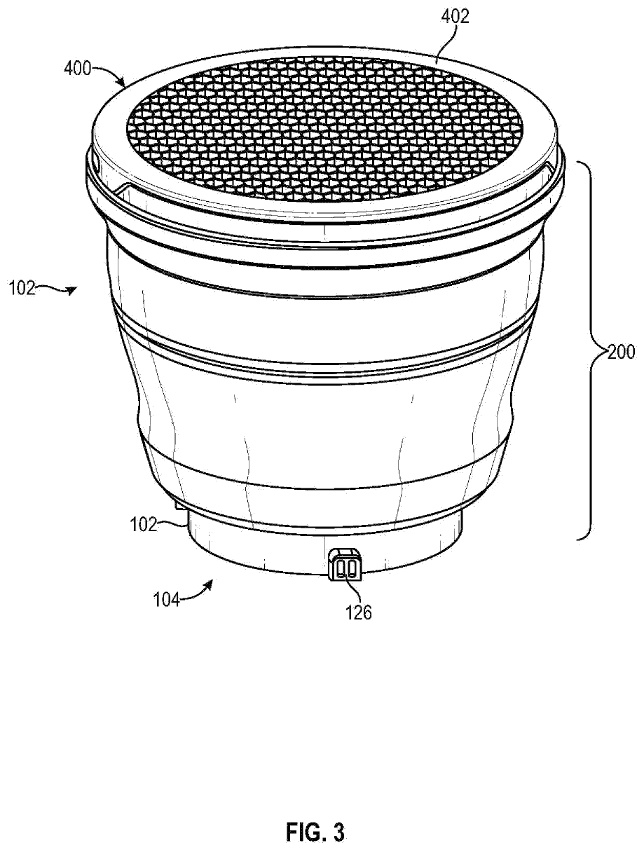

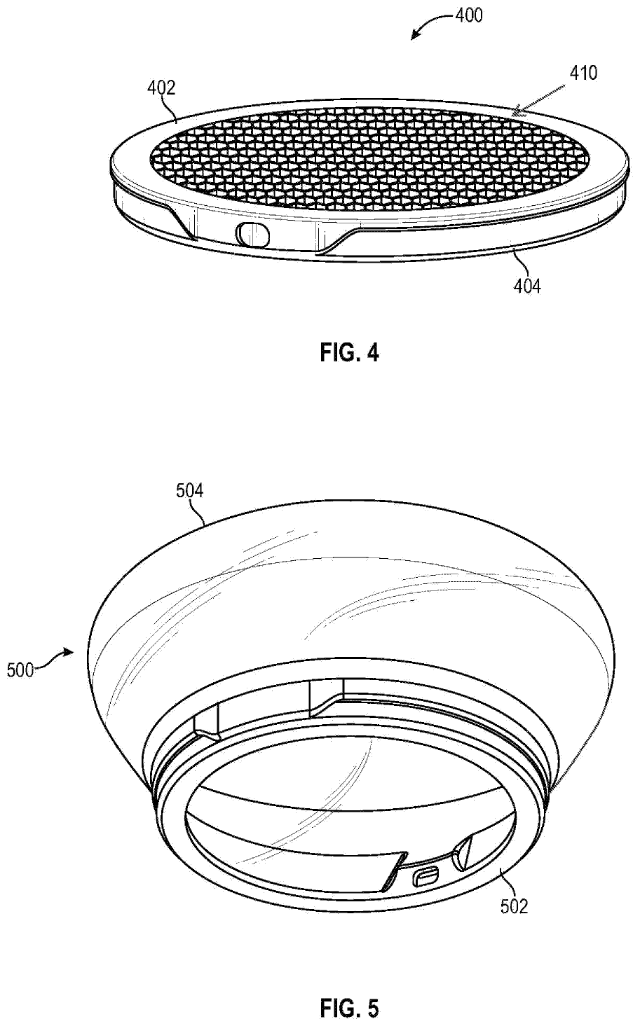

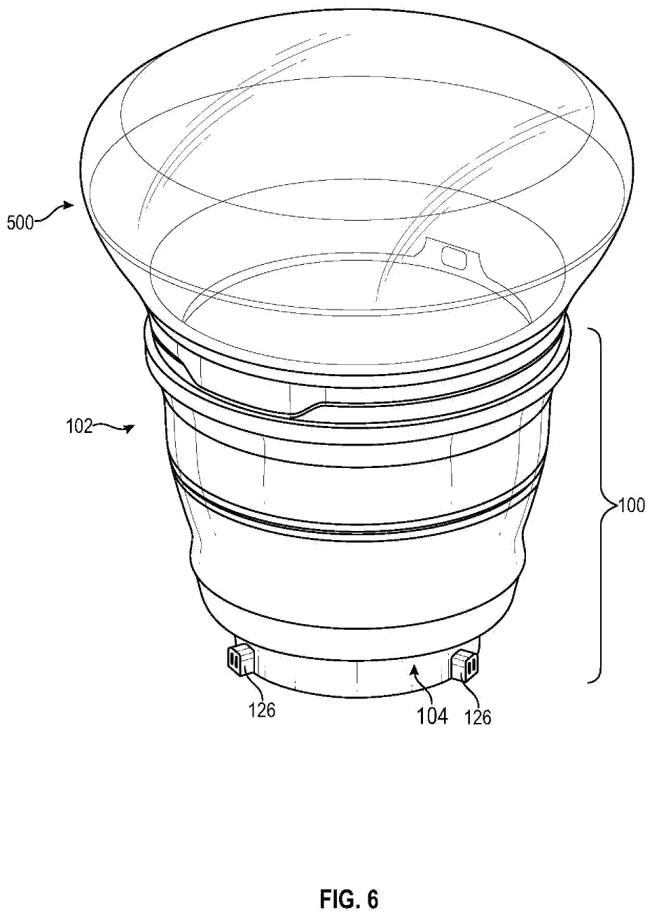

With references to FIGS. 3-6, FIG. 3 illustrates a perspective view of an example base modifier assembly 300 coupled to a first additional light-altering device 400; FIG. 4 illustrates an example of a first additional light-altering device 400 in the form of a grid; FIG. 5 illustrates an example of an additional light-altering device 500 in the form a dome diffuser; and FIG. 6 illustrates a perspective view of an example base modifier assembly 100 coupled to an additional light-altering device 500. It will be appreciated that elements described/numbered the same as with reference to FIGS. 1A-1D and FIG. 2 will have the same or similar properties as what has been described above.

First additional light-altering device 400 is illustrated as a light-diffusing grid having a substantially flat front face 402 opposite a substantially flat back face 404, with a grid structure 410 disposed between the substantially flat front face 402 and the substantially flat back face 404. It will be appreciated that the additional light-altering device may also be a snoot, a gel, a cone, a diffuser, or another device. In examples, the additional light-altering device 400 is adapted to couple to the modifier face 129 or other structure of a light modifier of a base modifier assembly, such as the light modifier 102 described above. FIG. 3 illustrates the additional light-altering device 400 removably coupled to the modifier distal end 111. In aspects of the technology, the modifier face 129 of the light modifier comprises a ferromagnetic material and/or one or more magnets that couple to the back face 404 of the first additional device. Additionally, the substantially flat back face 404 may also comprise a ferromagnetic material and/or one or more magnets that couples to the modifier face 129. For example, one or more of the flat back face 404 and the modifier face 129 may include one or more magnets and/or steel or other ferromagnetic material.

With reference to FIG. 5., additional light-altering device 500 is illustrated as a diffuser having a substantially flat back face 502. In aspects, the substantially flat back face 502 engages with a face of a light modifier, such as modifier face 129 of the light modifier 102 comprises a ferromagnetic material and/or one or more magnets that couples to the substantially flat back face 502 of the second additional light-altering device 500. Additionally, the substantially flat back face 502 may also be a ferromagnetic material that couples to the modifier face 129. For example, one or more of the backside 504 and the modifier face 129 may include a magnet. Additionally, the back face 502 may couple to another device, such as the first additional light-altering device 400. Such coupling may occur by the back face 502 coupling substantially flush with the substantially flat front face 402 of the first additional device.

FIG. 6 illustrates an example of a second additional light-altering device 500 coupled to the base modifier assembly 100. As illustrated, FIG. 6 has a first additional light-altering device 500 coupled to the modifier face 129 of a light modifier 102. It will be appreciated that other configurations are possible, including having multiple grids, one or more gels, a snoot or other conically shaped peripheral device, etc., coupled to assembly using the technology described herein. In examples, additional devices may be stacked on each other. For example, a first additional device, such as a first additional light-altering device 400, having a substantially flat front face may couple to another additional device. Such other additional devices include the second additional light-altering device 500. One configuration of such coupling includes the first additional light-altering device 400 having a substantially flat front face 402 that comprises at least one of a ferromagnetic material and/or at least one magnet that magnetically couples to the back face 502. In such a configuration, the back face 502 may comprise one or more of a ferromagnetic material and/or at least one magnet.

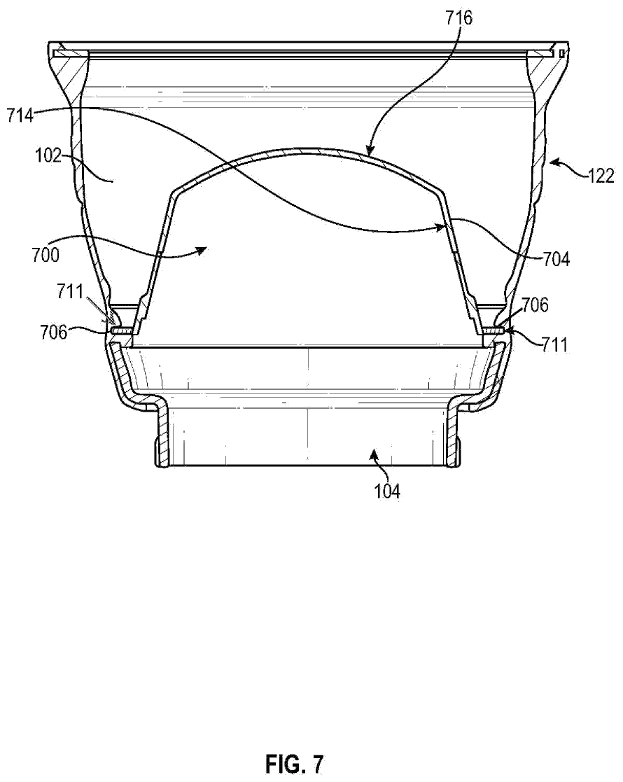

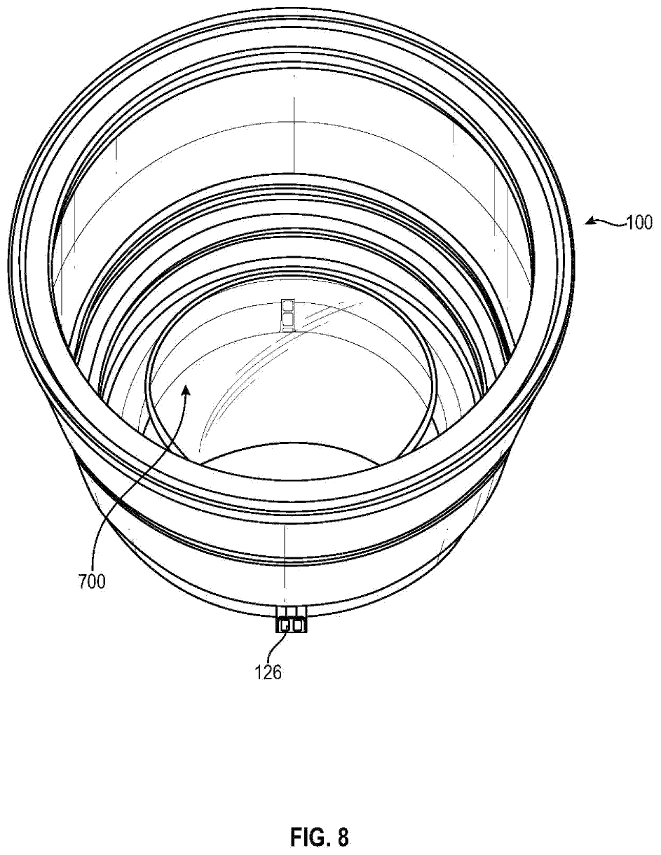

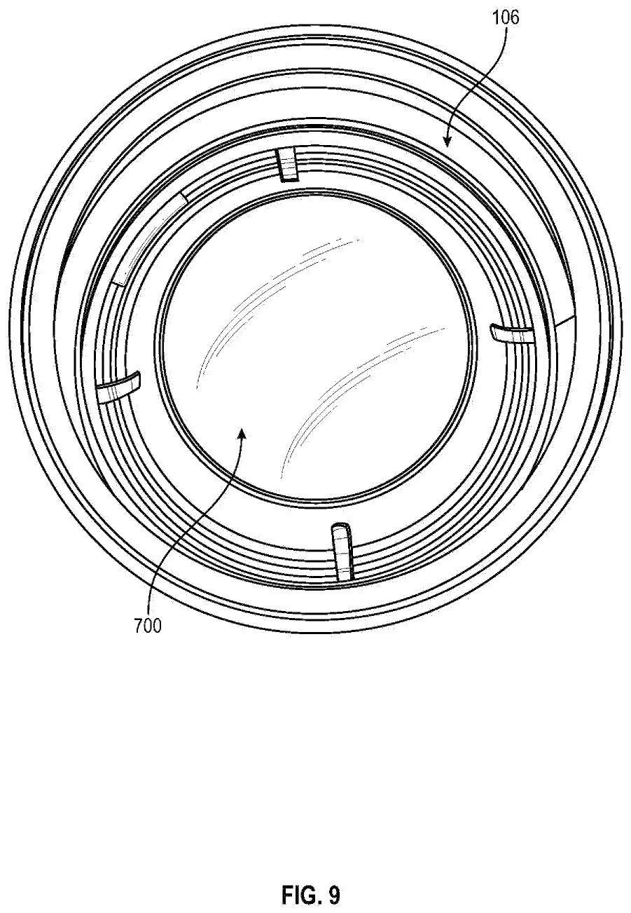

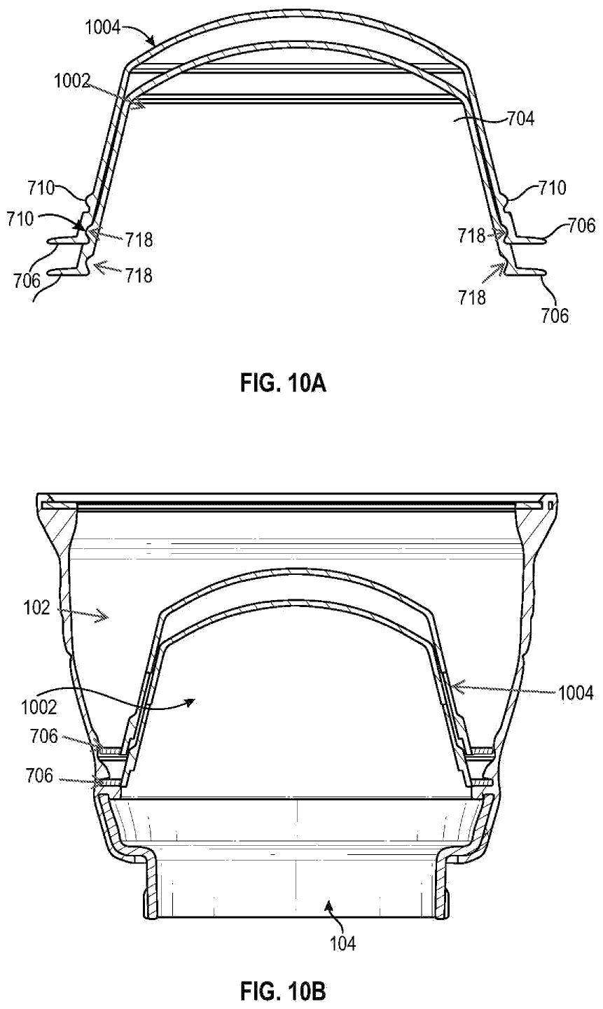

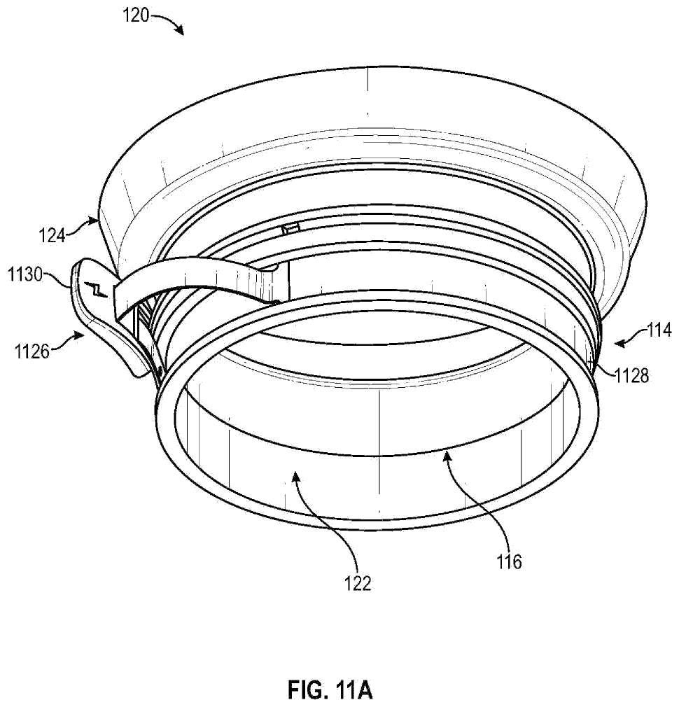

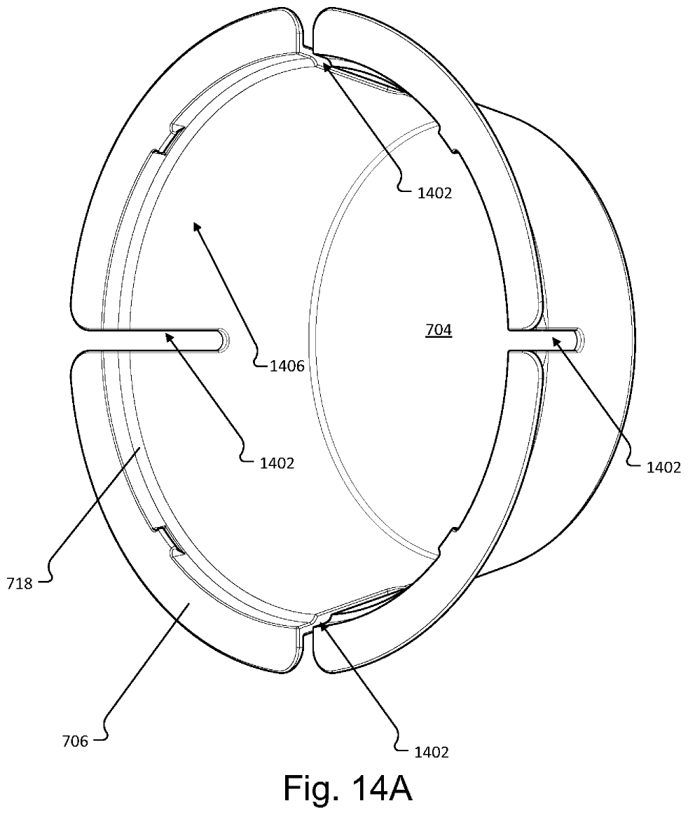

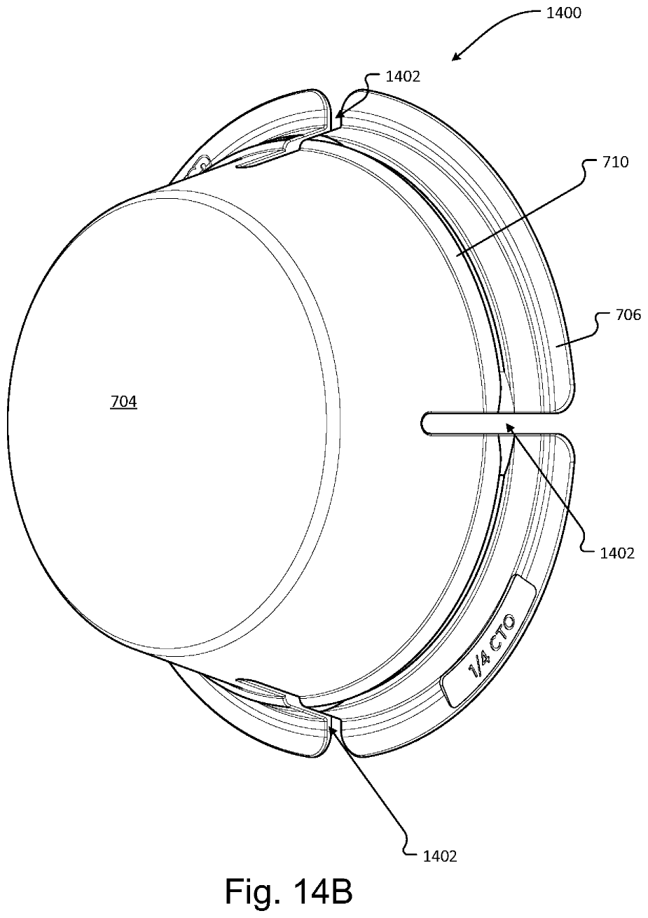

With references to FIGS. 7-10 and FIGS. 14A and 14B, FIG. 7 illustrates a cross-sectional view of an example base modifier assembly with an example gel insert 700, FIG. 8 illustrates a perspective view of an example base modifier assembly with an example gel insert 700, FIG. 9 illustrates a top view of an example base modifier assembly with an example gel insert 700, and FIGS. 10A and 10B illustrate a cross-section view of an example base modifier assembly a first gel insert 1002 and a second gel insert 1004 stacked on top of the first gel insert 900. FIGS. 14A and 14B illustrate various perspective views of an example gel insert 1400. It will be appreciated that elements described/numbered the same above will have the same or similar properties as what has been described above.

In aspects of the technology, a gel insert 700 comprises a body 704 having a lip 706 circumferentially disposed about an outer edge 708 of the body 704 having an inside surface 714 and an outside surface 716. The gel insert 700 may be the same or similar to the gel insert 1400 illustrated with reference to FIGS. 14A and 14B. As illustrated, the lip 706 is adapted to be removably coupled to one or more channels 711 circumferentially disposed about the base interior surface 122 of the attachment base 104. In alternative/additional examples, the lip 706 may be received by a channel circumferentially 711 disposed about the modifier interior surface 106 of the light modifier 102. The channel 711 may be sized such that the lip 706 may be press fit into the channel 711 of either the light modifier 102 and/or the attachment base 104. It will be appreciated that more than one or more channels may receive one or more gels (or other elements having a lip adapted to be received by a channel, such as a grid, a planar diffuser, etc.).

In aspects, the body 704 of the gel inserts 700, 1002, 1004, and 1400 includes one or more bumps 710 at least partially circumferentially disposed on the outside surface 716 about the base 712 of the body 704. A bump 710 may be where some of the material of the body 704 is raised relative to the rest of the body 704. The one or more bumps 710 may be used to engage with another device, such as another gel insert. FIG. 10A illustrates an example where an engagement element 718 of a second gel insert 1004 interacts with a bump 710 of a first gel insert 1002. It will be appreciated that the second gel insert 1004 and the first gel insert 1002 may be the same or similar to the gel insert described with reference to FIGS. 14A and 14B and/or gel insert 700. The engagement element 718 may be a channel corresponding to the one or more bumps 710. For example, an engagement element 718 that is a channel may be sized and shaped to receive at least one bump or protrusion of another gel. The engagement element 718 may be at least partially disposed about an inside surface 1406. In examples, one or more notches 1402 are present in the body 704 to allow the body 704 to more easily elastically deform. In examples, such elastic deformation allows a user to more easily engage the lip 706 with an interior surface of a light modifier 102 or an attachment base 104. It will be appreciated that while gels 1002 and 1004 are illustrated as having substantially the same structure as one another, a first gel and a second gel may have different structures.

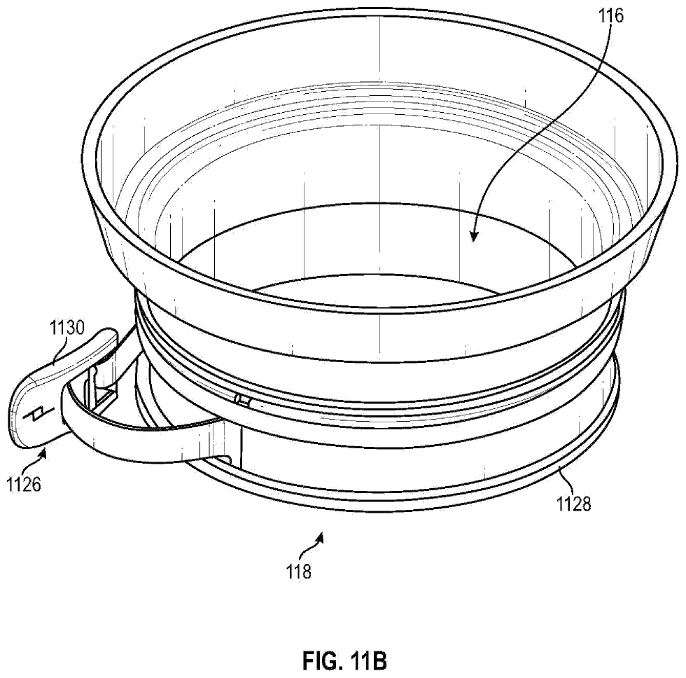

FIG. 11A illustrates a bottom-perspective view of an alternative attachment base 1100 and FIG. 11B illustrates a top-perspective view of an alternative attachment base 1100. It will be appreciated that elements similarly numbered as those elements discussed above will have the same or similar properties as those discussed above.

As illustrated, attachment base 104 includes a base body 114 defining a base opening 116. The illustrated attachment base 104 has a base proximal end 118 (e.g., proximal to the light source, not shown) and a base distal end 120. The base opening 116 passes through the base proximal end 118 to the base distal end 120, forming a base interior surface 122 and a base exterior surface 124 of the base body 114.

The base body 114 may be made of a variety of materials. In examples, the base body 114 is made of various types of materials, such as rigid plastic or metal for durability, stability, and flexibility, and/or elastomeric materials to allow for bending or flexing of the design. For some applications, the body is made of a heat-resistant material to resist heat damage when the base body 114 is put in use proximate to a bulb of a lighting element. For certain applications, a flexible, elastomeric material is desired to provide additional versatility and assist with a collapsible design, as further described herein.

As illustrated, on the base exterior surface 124 disposed near the base proximal end 118 is an attachment band assembly 1126. The illustrated attachment band assembly 1126 includes a strap 1128 and a clasp 1130. In examples, a lighting element housing may be inserted into the base opening 116 at the base proximal end 118. The user may use the clasp 1130 to tighten the strap 1128 thus providing a force radially inward toward the center of the base opening 116. This allows, for some applications, robust coupling of the attachment base 1100 to the lighting equipment. The base body 114 may be made of a material capable of elastically deforming so that the base proximal end 118 may be compressed, allowing for deformation such that base body 114 may deform around a light source housing. The base body 114 may be made of an elastomeric material so as to be able to couple to a variety of sizes of a light housing.

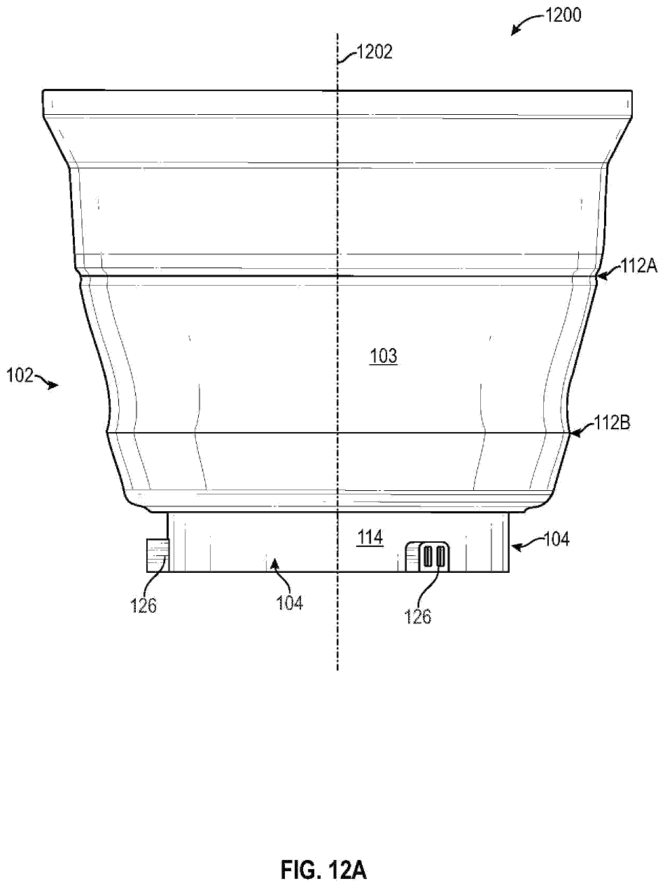

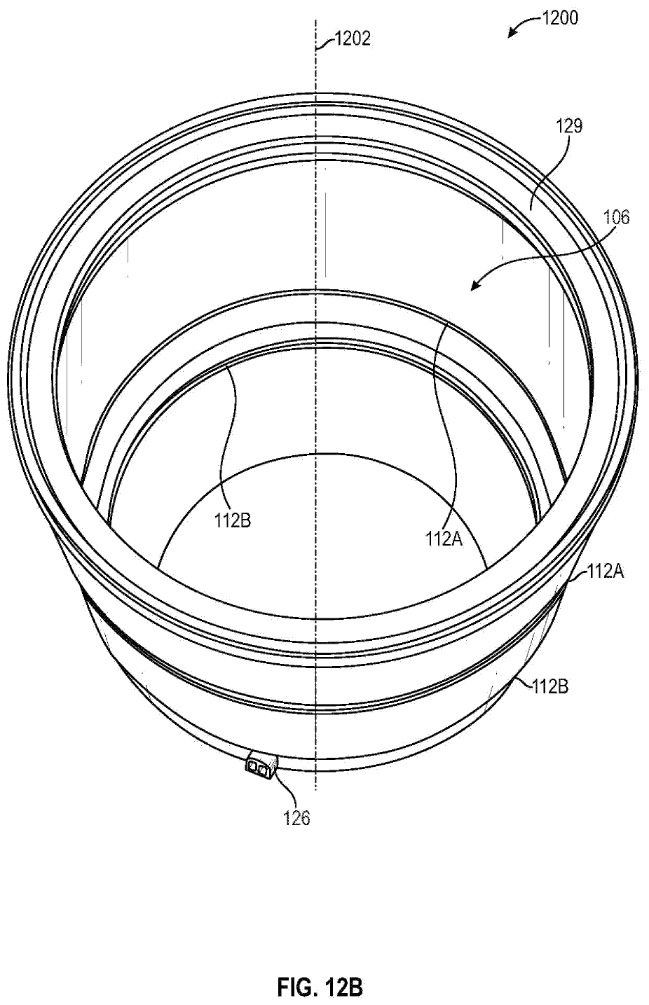

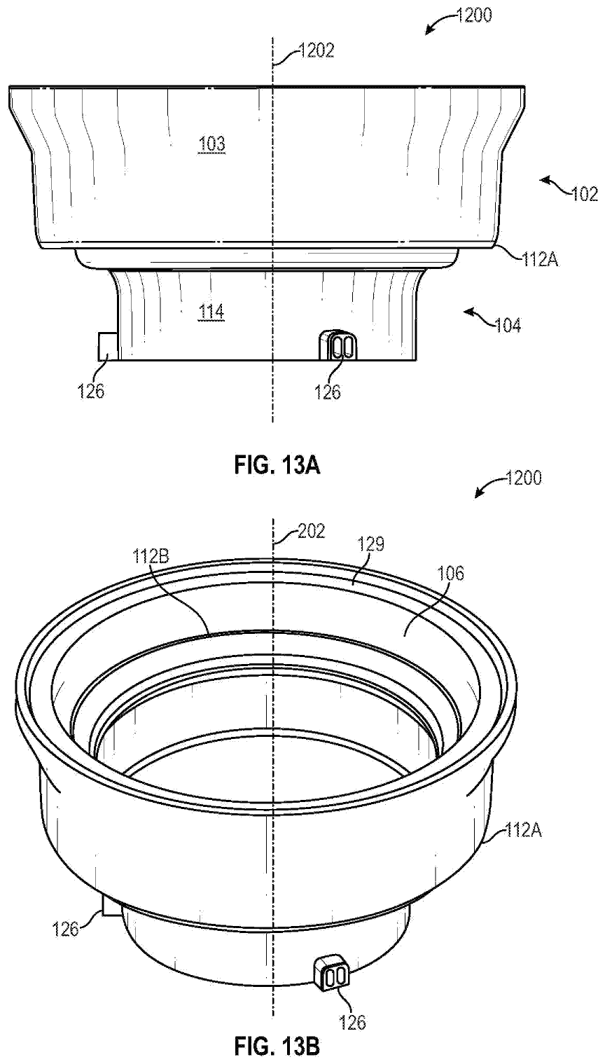

FIG. 12A illustrates a front view of an un-collapsed base modifier assembly 1200 collapsible along a first crease 112A and a second crease 112B. FIG. 12B illustrates a perspective view of an un-collapsed base modifier assembly 1200 collapsible along a first crease 112A and a second crease 112B. FIG. 13A illustrates a front view of a collapsed base modifier assembly 1200 collapsed along a first crease 112A and a second crease 112B. FIG. 13B illustrates a perspective view of a collapsed base modifier assembly 1200 collapsed along a first crease 112A and a second crease 112B. It will be appreciated that elements similarly numbered as those elements discussed above will have the same or similar properties as those discussed above. While illustrated as a base modifier assembly 1200 with a light modifier 102 and an attachment base 104, it will be appreciated that the technology disclosed is not so limited. Indeed, in some examples, the base modifier is of a unitary construction with light modifier 102 being irremovably coupled to the attachment base 104. For example, the light modifier 102 may comprise a front area of an apparatus, and the attachment base 104 may comprise a back area of that same apparatus. That is, the attachment base 104 and the light modifier 102 may form a unitary body, and each may be referred to as an attachment base area 104 and a light modifier area 102.

As illustrated, an axis 1202 runs parallel down the center of the base modifier assembly 1200. It will be appreciated that a user may apply a force parallel to the axis 1202 to cause the device to collapse along a first crease 112A and a second crease 112B. While two creases are shown, it will be appreciated that more or less creases may be used. The creases may be formed by creating a channel or pre-fold such that the force causes the body to collapse along the crease. For example, creating a crease 112A may slightly weaken the area of the modifier body 103 such that it deforms easier in the presence of a force parallel to the axis 1202 than the other portions of the modifier body 103 that do not have a crease or channel. Similarly, a crease 112B may slightly weaken the area of the base body 114 such that the crease 112B deforms easier in the presence of a force parallel to the axis 1202 than the other portions of the modifier body 103 that do not have a crease or channel.

It will be clear that the systems and methods described herein are well adapted to attain the ends and advantages mentioned as well as those inherent therein. Those skilled in the art will recognize that the methods and systems within this specification may be implemented in many manners and, as such, is not to be limited by the foregoing exemplified embodiments and examples. In other words, functional elements being performed by a single or multiple components and individual functions can be distributed among different components. In this regard, any number of the features of the different embodiments described herein may be combined into one single embodiment and alternate embodiments having fewer than or more than all of the features herein described as possible.

What is claimed:

1. A light modification assembly comprising:
a base having a base body defining a base opening having a base interior surface, the base body having a base distal end opposite a base proximal end and at least one base exterior surface, wherein the base exterior surface of the base body includes at least one attachment element capable of removably coupling to a lighting element;
a light modifier having a modifier body defining a modifier opening, the modifier body having a modifier distal end opposite a modifier proximal end and at least one modifier exterior surface, the at least one modifier exterior surface having a modifier coupler proximate to the modifier proximal end removably coupled to at least a portion of the base interior surface.

2. The light modification assembly of claim 1, wherein the at least one attachment element is one or more protrusions extending radially from an outside surface of a proximal end of the base, wherein the at least one attachment element is operatively configured to couple with a lighting element.

3. The light modification assembly of claim 1, wherein the modifier coupler comprises a bottom surface comprising one or more ferromagnetic materials.

4. The light modification assembly of claim 3, wherein removably coupling to the light modifier occurs through a friction fit, press fit, a belt and clasp, a hook and loop fastener, or snap fit.

5. The light modification assembly of claim 1 wherein the light modifier further comprises an interior surface disposed within the modifier opening, wherein the interior surface is reflective or semi reflective.

6. The light modification assembly of claim 1, wherein the light modifier is collapsible along one or more creases or channels.

7. The light modification assembly of claim 1, further comprising a gel insert having a body and a lip disposed on an outside rim of the base of the gel, the lip removably coupled to one of: a channel disposed about an interior surface of the light modifier or a channel disposed about a base interior surface of the base.

8. The light modification assembly of claim 7, wherein the gel further comprises:
a bump circumferentially disposed about an outside surface of the gel.

9. The light modification assembly of claim 1, further comprising a gel having a body and a lip disposed on an outside rim of the base of the gel, the lip removably and magnetically coupled to an interior surface of the light modifier or the base interior surface of the base.

10. The light modification assembly of claim 1, further wherein the light modifier further comprises a face proximate to the modifier distal end, wherein the face includes one or more elements adapted to receive an additional light modification device.

11. The light modification assembly of claim 10, wherein the additional light modification device is a grid or a diffuser that is capable of coupling to the face via a ferromagnetic attachment.

12. The light modification assembly of claim 8, further comprising a second gel having an inside surface with a channel circumferentially disposed along an interior surface of the second gel, the channel removably coupled to the bump of the gel.

13. A light modification apparatus comprising:
a base area as part of a body defining an opening having a interior surface area, the body having a distal end opposite a proximal end and at least one exterior surface, wherein the exterior surface of the body includes at least one attachment element proximate to the proximal end capable of removably coupling to a lighting element; and
a light modification area proximate to the distal end.

14. The light modification apparatus of claim 13, wherein the at least one attachment element is one or more protrusions extending radially extending from the exterior surface, and further wherein the at least one attachment element is operatively configured to couple with a lighting element.

15. The light modification apparatus of claim 14, wherein the interior surface is reflective or semi reflective.

16. The light modification apparatus of claim 13, wherein the light modification apparatus is a unitary body collapsible alone one or more creases or channels.

17. The light modification apparatus of claim 13, further comprising a gel having a body and a lip disposed on an outside rim of the base of the gel, the lip removably coupled to a channel disposed circumferentially about the interior surface.

18. The light modification apparatus of claim 17, wherein the gel further comprises:
a bump circumferentially disposed about an outside surface of the gel.

19. The light modification apparatus of claim 18, further comprising a second gel having an inside surface with a channel circumferentially disposed about an interior surface of the second gel, the channel removably coupled to the bump of the gel.

20. The light modification apparatus of claim 13, wherein the light modification area comprises a face proximate to the distal end, wherein the face includes one or more elements adapted to receive an additional light modification device.
